(19) United States
(12) Patent Application Publication
(10) Pub. No.: US 2006/0221946 A1
(43) Pub. Date: Oct. 5, 2006

(54) CONNECTION ESTABLISHMENT ON A TCP OFFLOAD ENGINE

(75) Inventors: Leah Shalev, Zichron-Yaakov (IL); Giora Biran, Zichron-Yaakov (IL)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: INTERNATIONAL BUSINESS MACHINES CORPORATION, Armonk, NY (US)

(21) Appl. No.: 10/907,507

(22) Filed: Apr. 4, 2005

(51) Int. Cl. H04L 12/56

(52) U.S. Cl. 370/389

(57) ABSTRACT

A method for performing connection establishment in TCP (transmission control protocol), the method including sending a SYN segment from a sender to a TCP offload engine (TOE), the SYN segment comprising a TCP packet adapted to synchronize sequence numbers on connecting computers, creating a connection context, acknowledging receipt of the SYN segment by sending a SYN/ACK segment to the sender, and sending an ACK segment from the sender to the TOE to acknowledge receipt of the SYN/ACK segment. Alternatively, the method may include sending a SYN segment from a sender to a computer, acknowledging receipt of the SYN segment by sending a SYN/ACK segment to the TOE, creating a connection context, and sending an ACK segment from the TOE to acknowledge receipt of the SYN/ACK segment.

### FIELD OF THE INVENTION

The present invention relates generally to implementations of TCP (transmission control protocol), and particularly to connection establishment on a TCP offload engine.

### BACKGROUND OF THE INVENTION

TCP connection typically includes connection establishment, data transfer and connection termination. A three-way handshake is typically used to establish a connection:

1. A SYN segment is sent to the server. SYN (synchronize) is a packet used by the TCP to synchronize the sequence numbers on two connecting computers. In a passive open, referred to as server-side connection establishment, the server passively listens for a connection from the client. In an active open, referred to as client-side connection establishment, the client initiates the connection by sending an initial SYN segment to the server.

2. The server responds to a valid SYN request with a SYN/ACK segment. ACK (acknowledge) is used to acknowledge receipt of a packet.

3. The client responds to the server with an ACK, completing the connection establishment.

Data transfer and connection termination follow, involving much processing. Typical TCP communication thus requires extensive processing power. As network transmission rates increase, software implementation of TCP/IP (Internet protocol) services may become a bottleneck in the performance of the system. A well-known solution in the prior art to this problem is to offload the TCP/IP processing to a TCP Offload Engine (TOE).

One approach involves complete offloading of the TCP/IP processing, including both data handling and connection establishment (or connection management) functions. This approach has serious security implications, because a network stack typically includes security policies that control which TCP connections are established and which refused. (A typical TCP/IP stack is a software component provided with the operating system (OS).) Due to the wide variety of possible security policies and frequent changes to the security techniques implemented, it is desirable to leave the software full control over the connection establishment.

However, when software is responsible for TCP connection establishment and a TOE is responsible for data processing, a problem can occur during the handover of control over the accepted TCP connection from the software to TOE, in the case of server-side connection establishment. If the connection handover is done after the complete connection establishment sequence (described above), then a data segment from the remote side (following ACK for SYN) may possibly arrive during the handover, that is, when the TOE was not yet set up for processing the connection. Such data segment would not be recognized by the TOE as a packet belonging to the offloaded connection. Therefore, the data segment would be passed to the software stack, which in turn would not be able to process it because the control over the connection has been passed to the hardware. Accordingly, such a packet would be discarded. This may seriously impact performance because TCP congestion control mechanisms may hinder recovering the loss of the first data packet. For example, normally at the beginning of data transfer, a single packet is sent to test out network congestion. If no ACK is received, the packet is resent after a 3-second timeout. With no way of recovering the data packet, the remote client would thus experience a significantly long period of response latency. A similar (although less probable) degradation in performance may occur on the client side as well.

### SUMMARY OF THE INVENTION

The present invention seeks to provide a solution for the above problem wherein partial support for the connection establishment is provided by the TOE, whereas the software has full control over security policies. The present invention provides improved connection establishment for both server-side connection and client-side connection, as is described more in detail hereinbelow.

### BRIEF DESCRIPTION OF THE DRAWINGS

The present invention will be understood and appreciated more fully from the following detailed description taken in conjunction with the appended drawings in which:

FIG. 1 is a simplified flow diagram illustration of connection establishment on the TOE in the case of passive opening by a remote application (server), wherein the TOE connection context is created in SYN-RECEIVED state, in accordance with an embodiment of the present invention; and

FIG. 2 is a simplified flow diagram illustration of connection establishment on the TOE in the case of active opening by a local application (client), wherein the TOE connection context is created in ESTABLISHED state, in accordance with an embodiment of the present invention.

### DETAILED DESCRIPTION OF THE EMBODIMENTS

A general, non-limiting overview of embodiments of the invention is first presented, followed by non-limiting examples of server-side connection establishment and client-side connection establishment.

A TCP/IP network stack includes software for control over security policies. In accordance with an embodiment of the present invention, the software may handle all necessary information related to security, such as but not limited to, handling of SYN packets, whereas a TCP offload engine (TOE) may perform certain parts of and complete the connection establishment, as is now explained.

A SYN segment or packet (i.e., TCP packet or packets with SYN flag set) may be sent to the server from a sender (e.g., a remote TCP client) to initiate the handshake of the connection establishment. The TOE may detect the SYN packets and pass them unprocessed to a connection manager (CM) on a raw channel (i.e., a channel containing network packets that are not handled by the TOE). The CM, which may be implemented in software, may create a connection context upon a request from the TOE, based on the received SYN segments. The CM (software) may then perform the next step of the handshake, that is, send SYN/ACK to the client. It is noted that SYN/ACK may still be transmitted and potentially retransmitted by the host software as a raw packet Acknowledgement (ACK) of the SYN/ACK packet may be handled by the TOE, wherein the ACK may be validated according to the TCP standard. The TOE is guaranteed to have the connection context ready at the time the ACK and the consequent data arrives, because the connection context has already been created. The TOE may report validation results to the CM through a control channel.

It is noted that in the prior art, the connection context is created only when the TCP connection is in the ESTABLISHED state. In contrast, in an embodiment of the present invention, the TOE connection context may be created either in the ESTABLISHED or in a SYN-RECEIVED connection state.

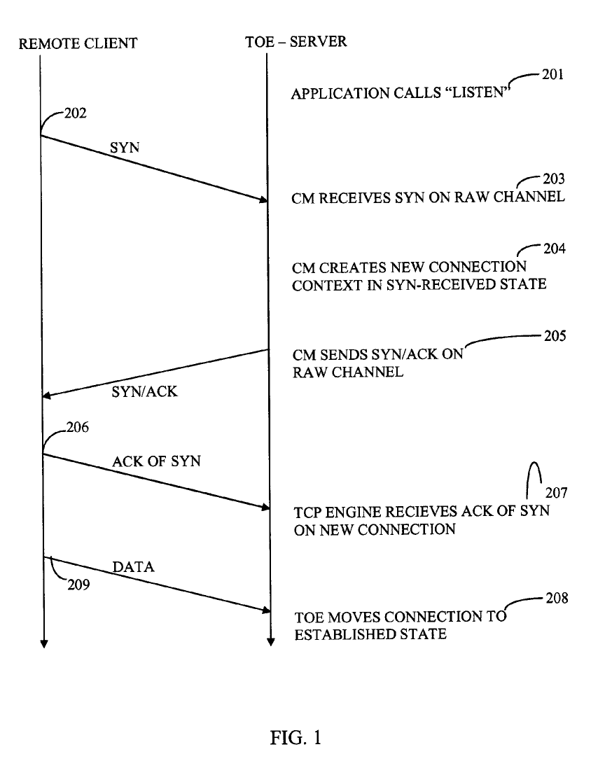

Reference is now made to FIG. 1, which illustrates a flow diagram of connection establishment on the TOE in the case of passive opening by a remote application (server), wherein the TOE connection context is created in SYN-RECEIVED state, in accordance with an embodiment of the present invention.

In the non-limiting illustrated embodiment, on the server side, the connection establishment may commence with the TCP server application requesting the CM to “listen” to a certain port (201). The CM may create a TCB (TCP control block data structure) in LISTEN state (for software implementation). The remote client may attempt to connect to the server, and may initiate the connection establishment handshake by sending a SYN segment with the TCP port number matching that of the TCB specified by the server in the LISTEN mode of operation (202). The TOE may recognize the arriving SYN segment as a TCP packet which carries SYN flag, and pass the segment to a raw channel. The CM may receive the SYN segment on the raw channel (203). When the CM finds that the TCB matches the port number, the CM may act in accordance with security policies and create a new TCB in SYN_RECEIVED state. The CM creates a TOE connection context with an indication that SYN-RECEIVED state has been set (204).

The CM may then send a SYN/ACK segment for the newly created connection on the raw channel (205). The CM may handle timeout for the SYN/ACK segment and retransmit the segment, if necessary. Afterwards, the remote client may send ACK of SYN/ACK to the TOE (206). When the TOE receives ACK, and the SYN-RECEIVED state indication in the connection context is set, the TOE may process the ACK segment (207) as follows:

1. Check the sequence number. If an appropriate invalidation bit (e.g., RST (reset) bit) is set, the TOE may invalidate the connection (e.g., by setting an appropriate indication in the context) and notifying the CM of such through a control channel.

2. The TOE may validate that the ACK segment acknowledges the sent SYN/ACK. If validation fails, the TOE may invalidate the connection by setting an appropriate indication in the context, and notifying the CM of such through the control channel. The control information may include the ACK number from the received packet (which enables the CM to build an appropriate RST segment). If validation passes, the TOE may notify the CM through the control channel.

The TOE may then move the TOE connection to ESTABLISHED state, e.g., by clearing the indication of the SYN-RECEIVED state in the connection context (208). Data transfer and connection termination may then follow as in the usual TCP (209).

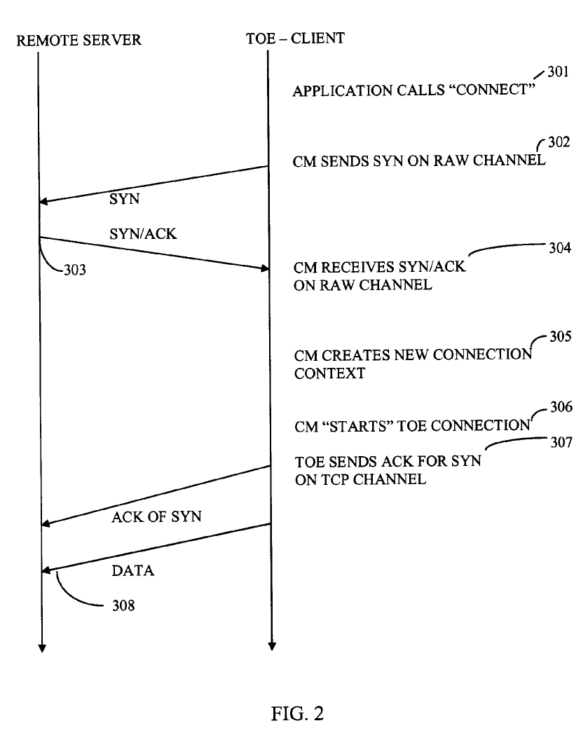

Reference is now made to FIG. 2, which illustrates a flow diagram of connection establishment on the TOE in the case of active opening by a local application (client), wherein the TOE connection context is created in ESTABLISHED state, in accordance with an embodiment of the present invention. In this embodiment, the TOE and CM are on the client side.

In the non-limiting illustrated embodiment, on the client side, the connection establishment may commence with the TCP client application requesting the CM to establish a connection (301). The client may provide address and port information for the destination and source. The CM may act in accordance with security policies and create a corresponding TCB in SYN-SENT state (for software implementation). The CM may send the SYN segment to the server (302), for example, on a raw channel. As in the embodiment of FIG. 1, the CM may handle timeout for the SYN segment and may retransmit, if necessary.

The remote TCP server may respond with a SYN/ACK segment (303). The TOE may recognize the arriving SYN/ACK segment as a TCP packet which carries a SYN flag, and may pass the segment to the raw channel. The CM may receive the SYN/ACK segment on the raw channel (304). The CM may then move the connection to the ESTABLISHED state, thereby creating a new connection context (305). In this connection context, the CM may set an indication of the pending ACK transmission, which will force ACK generation by the TOE. The CM may then activate the TOE in order to trigger ACK transmission (306). The TOE may send acknowledgement (ACK) for the SYN/ACK segment on the newly created connection (307). The TOE may process the ACK segment as described hereinabove with reference to the embodiment of FIG. 1 (step 207). Data transfer and connection termination may then follow as in the usual TCP (308).

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for performing connection establishment in TCP (transmission control protocol), the method comprising:
sending a SYN (synchronize) segment from a sender to a TCP offload engine (TOE), said SYN segment comprising a TCP packet adapted to synchronize sequence numbers on connecting computers;
creating a connection context;
acknowledging receipt of the SYN segment by sending a SYN/ACK (synchronize/acknowledge) segment to the sender; and
sending an ACK (acknowledge) segment from the sender to said TOE to acknowledge receipt of the SYN/ACK segment.

2. The method according to claim 1, wherein said TOE passes the SYN segment to a connection manager (CM), and said connection manager creates the connection context upon a request from the TOE, based on the SYN segment, in a SYN-RECEIVED connection state.

3. The method according to claim 2, wherein the SYN/ACK segment is sent to the sender by said connection manager.

4. The method according to claim 2, further comprising validating the ACK segment by the TOE and reporting validation results to the CM.

5. The method according to claim 2, further comprising, prior to sending the SYN segment, requesting the CM to listen for a SYN segment being sent from the sender.

6. The method according to claim 5, wherein said CM creates a TCB (TCP control block data structure) in a LISTEN mode of operation, and the SYN segment has a TCP port number that matches that of said TCB.

7. The method according to claim 1, wherein said TOE processes the ACK segment, and if an appropriate invalidation bit is set, said TOE invalidates the connection establishment.

8. The method according to claim 1, further comprising, after completing the connection establishment, performing TCP data transfer.

9. A method for performing connection establishment in TCP, the method comprising:
sending a SYN segment from a sender to a computer;
acknowledging receipt of the SYN segment by sending a SYN/ACK segment to a TCP offload engine (TOE);
creating a connection context; and
sending an ACK segment from said TOE to acknowledge receipt of the SYN/ACK segment.

10. The method according to claim 9, wherein said TOE passes the SYN/ACK segment to a connection manager (CM), and said connection manager creates the connection context in an ESTABLISHED connection state.

11. The method according to claim 10, further comprising, prior to sending the SYN segment, the sender requesting the CM to establish a connection.

12. The method according to claim 10, wherein prior to sending the SYN segment, said CM creates a TCB in a SYN-SENT mode of operation.

13. The method according to claim 10, wherein the SYN segment is sent by said CM.

14. The method according to claim 10, wherein said CM activates said TOE in order to trigger sending the ACK segment.

15. The method according to claim 10, further comprising validating the ACK segment by the TOE and reporting validation results to the CM.

16. The method according to claim 9, wherein said TOE processes the ACK segment, and if an appropriate invalidation bit is set, said TOE invalidates the connection establishment.

17. The method according to claim 9, further comprising, after completing the connection establishment, performing TCP data transfer.
